(19) United States
(12) Patent Application Publication
(10) Pub. No.: US 2025/0327953 A1
(43) Pub. Date: Oct. 23, 2025

(54) ANGULARLY ADJUSTABLE FRESNEL TURNING LENS AND IMPLEMENTATION METHOD THEREOF

(71) Applicant: Hengdian Group Tospo Lighting Co., Ltd., Jinhua City (CN)

(72) Inventors: Junchu SI, Jinhua (CN); Yidi Chen, Jinhua (CN); Kan Li, Jinhua (CN); Quanfei Hu, Jinhua (CN); Xinqiang Guo, Jinhua (CN); Haotian Zhou, Jinhua (CN)

(21) Appl. No.: 19/031,476

(22) Filed: Jan. 18, 2025

(30) Foreign Application Priority Data
Apr. 22, 2024 (CN) 202410483473.5

(51) Int. Cl. G02B 3/08

(52) U.S. Cl. CPC G02B 3/08

(57) ABSTRACT

Disclosed is an angularly adjustable Fresnel turning lens, including a lens body, where one side surface of the lens body is a surface A, and the other side surface of the lens body is a surface B, where a convex cambered surface is provided at a middle position of the surface A, and a third convex surface, a second convex surface, and a first convex surface are provided successively at an outer side of the convex cambered surface; a concave cambered surface is arranged at a middle position of the surface B. An implementation method of the angularly adjustable Fresnel turning lens is also disclosed. In the present disclosure, a light-emitting angle may be adjusted only by turning the lens body, and compared with the focusing mode in the related art, this lens has the features of a smaller amount of material and a smaller weight and volume, thereby reducing the cost of the lens. The loss of optical efficiency caused by the conventional focusing mode is avoided, and meanwhile, only one layer of optical structure is provided, thereby reducing the loss of luminous flux. The angle adjustment is realized by turning, thereby improving the space utilization.

### CROSS-REFERENCES TO RELATED APPLICATIONS

This application claims the benefit of Chinese patent application No. 202410483473.5, filed on 22 Apr. 2024, entitled “ANGULARLY ADJUSTABLE FRESNEL TURNING LENS AND IMPLEMENTATION METHOD THEREOF”, the entire contents of which are incorporated by reference herein.

### TECHNICAL FIELD

The present disclosure belongs to the technical field of lenses, and particularly relates to an angularly adjustable Fresnel turning lens and an implementation method thereof.

### BACKGROUND

With the continuous development of lighting technology, people are no longer satisfied with a single fixed lighting mode, but can adjust the angle of light according to the needs of the scene to achieve effective use of light.

Currently, the mainstream zooming modes on the market include the following modes.

(1) Angle adjustment through a single lens: the distance from the light source to the lens is adjusted by changing the position of the lens to realize the change of the light-emitting angle. In this way, the change of optical efficiency will occur after adjusting the focal length, resulting in the loss of luminous flux.

(2) Angle adjustment through double lenses: the relative positions of the concave and convex of the two layers of lenses are adjusted, and a light path is changed to adjust the angle. In this way, it is necessary to pass through two layers of optical structures, and the loss of luminous flux is large.

(3) Angle adjustment through rotating a lens: the angular transformation can be realized by rotating the lens through annular stretching of the free-form surface lens and alternate arrangement of the optical surfaces with a small angle and a large angle. In this way, the utilization of the optical surfaces is not high, and when using a lens with a large-angle section, a lens with a small-angle section is left idle.

### SUMMARY

An object of the present disclosure is to provide an angularly adjustable Fresnel turning lens to solve the problems set forth in the above background. The angularly adjustable Fresnel turning lens provided by the present disclosure has the features of a smaller amount of material, a smaller weight and volume, reducing the loss of luminous flux, and improving the space utilization.

Another object of the present disclosure is to provide an implementation method of the angularly adjustable Fresnel turning lens.

In order to achieve the above-mentioned objects, the present disclosure provides the following technical solutions. A Fresnel lens is provided, including a lens body, where one side surface of the lens body is a surface A, and the other side surface of the lens body is a surface B, where a convex cambered surface is provided at a middle position of the surface A, and a third convex surface, a second convex surface, and a first convex surface are provided successively at an outer side of the convex cambered surface; a concave cambered surface is arranged at a middle position of the surface B, the lens body is capable of being turned over to adjust a light-emitting angle of the Fresnel lens.

Further, in the present disclosure, the convex cambered surface has a thickness of 0.6 mm.

Further, in the present disclosure, the first convex surface, the second convex surface, and the third convex surface all have a zigzag structure.

Further, in the present disclosure, a distance between a convex point of the first convex surface and a central point of the lens body is 4.8 mm, a distance between a convex point of the second convex surface and the central point is 3 mm, and a distance between a convex point of the third convex surface and the central point is 1.6 mm.

Further, in the present disclosure, each of the first convex surface, the second convex surface, and the third convex surface includes an incident surface and an emitting surface, and the incident surface is provided opposite to the emitting surface.

Further, in the present disclosure, an angle between the incident surface of the first convex surface and a horizontal plane is 135°, an angle between the incident surface of the second convex surface and the horizontal plane is 120°, and an angle between the incident surface of the third convex surface and the horizontal plane is 100°.

Further, in the present disclosure, the concave cambered surface has a thickness of 0.7 mm.

Further, in the present disclosure, the method of adjusting the light-emitting angle of the Fresnel lens includes the steps of:
selecting one of the surface A and the surface B of the lens body as a light incident surface to allow the Fresnel lens to emit light at a first light-emitting angle; and
turning over the lens body to enable the other of the surface A and the surface B of the lens body to be a light incident surface to allow the Fresnel lens to emit light at a second light-emitting angle, thereby adjusting the light-emitting angle of the Fresnel lens.

Further, when the surface A of the lens body is the light incident surface, first light rays are incident into the lens body through the convex cambered surface and then emitted, second light rays are converged through the first convex surface, the second convex surface, and the third convex surface, and then emitted at the first light-emitting angle, and the first light-emitting angle is a smaller angle than the second light-emitting angle;
when the surface B of the lens body is the light incident surface, first light rays are incident into the lens body through the concave cambered surface and then emitted at the convex cambered surface of the light-emitting surface, second light rays are incident via the concave cambered surface and then diffused through the first convex surface, the second convex surface, and the third convex surface, and then emitted at the second light-emitting angle, and the second light-emitting angle is a larger angle than the first light-emitting angle.

Compared with the prior art, the beneficial effects of the present disclosure are as follows.

1. In the present disclosure, a light-emitting angle may be adjusted only by turning the lens body, and compared with the focusing mode in the prior art, this lens has the features of a smaller amount of material and a smaller weight and volume, thereby reducing the cost of the lens.

2. In the present disclosure, the loss of optical efficiency caused by the conventional focusing mode is avoided, and meanwhile, only one layer of optical structure is provided, thereby reducing the loss of luminous flux.

3. In the present disclosure, the angle adjustment is realized by turning, thereby improving the space utilization.

### BRIEF DESCRIPTION OF THE DRAWINGS

FIG. 1 is a schematic structural diagram of a surface A of a lens body of the present disclosure;

FIG. 2 is a schematic structural diagram of a surface B of a lens body of the present disclosure;

FIG. 3 is a schematic cross-sectional view of a lens body of the present disclosure;

FIG. 4 is a schematic diagram showing the refraction of light rays when a surface B of a lens body of the present disclosure is a light incident surface;

FIG. 5 is a schematic diagram of light distribution when a surface B of a lens body of the present disclosure is a light incident surface;

FIG. 6 is a schematic diagram showing the refraction of light rays when a surface A of a lens body of the present disclosure is a light incident surface; and

FIG. 7 is a schematic diagram of light distribution when a surface A of a lens body of the present disclosure is a light incident surface.

In the drawings: 1—lens body; 2—surface A; 3—first convex surface; 4—second convex surface; 5—third convex surface; 6—convex cambered surface; 7—surface B; and 8—concave cambered surface.

### DETAILED DESCRIPTION

The technical solutions in the embodiments of the present disclosure will be clearly and completely described below in conjunction with the accompanying drawings in the embodiments of the present disclosure. Obviously, the described embodiments are only some embodiments of the present disclosure, not all embodiments. Based on the embodiments of the present disclosure, all other embodiments obtained by a person skilled in the art without inventive effort fall within the scope of the present disclosure.

### Embodiment 1

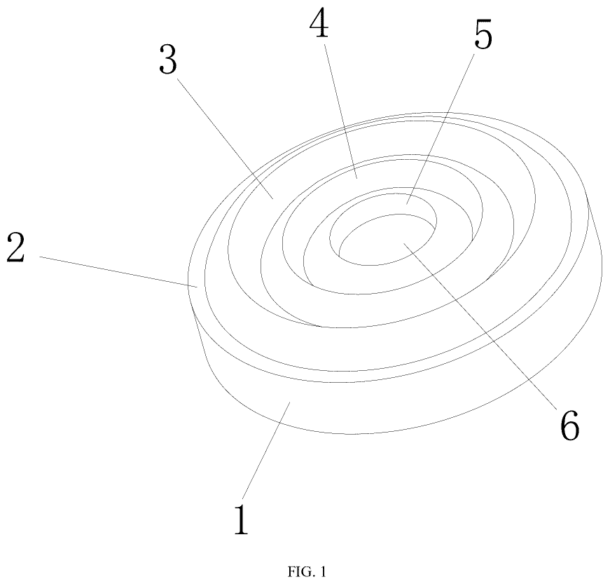

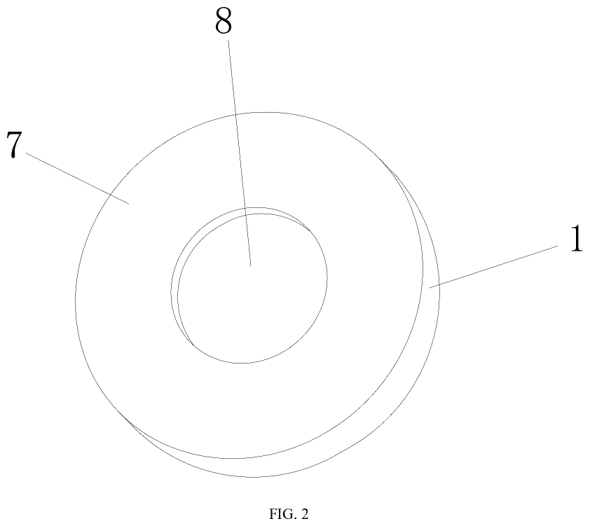

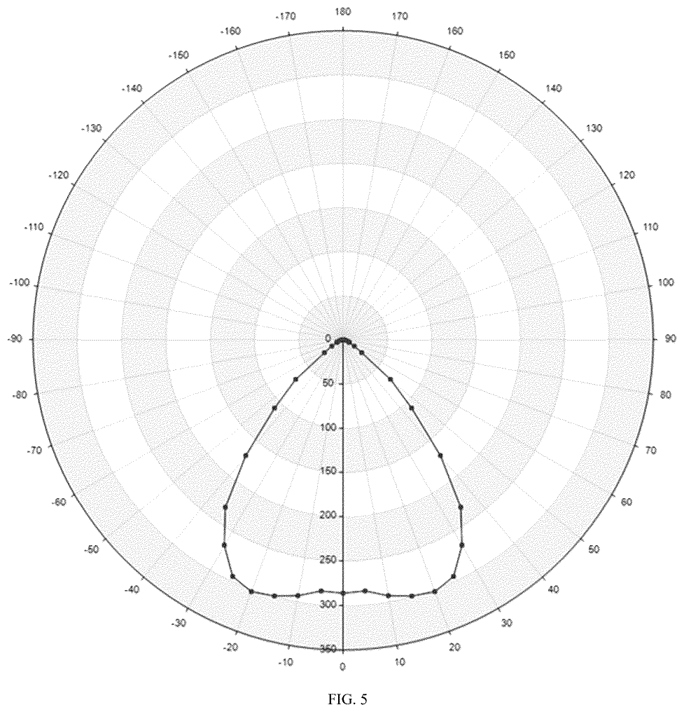

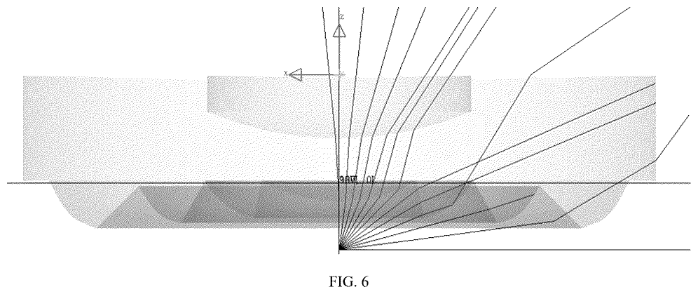

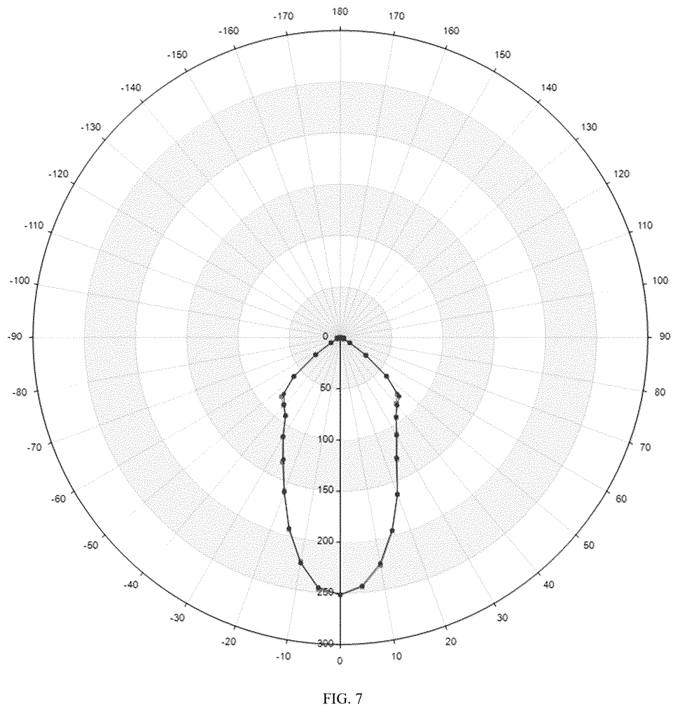

Referring to FIGS. 1-7, the present disclosure provides the following technical solutions. An angularly adjustable Fresnel turning lens is provided, including a lens body 1. One side surface of the lens body 1 is a surface A 2, and the other side surface of the lens body 1 is a surface B 7. A convex cambered surface 6 is provided at a middle position of the surface A 2, and a third convex surface 5, a second convex surface 4, and a first convex surface 3 are provided successively at an outer side of the convex cambered surface 6. A concave cambered surface 8 is arranged at a middle position of the surface B 7.

According to the above-mentioned technical solution, in the present disclosure, when the surface A of the lens body 1 is a light incident surface, a part of light rays is incident into the lens body 1 through the convex cambered surface 6 and then emitted. Another part of light rays is converged through the first convex surface 3, the second convex surface 4, and the third convex surface 5 and then emitted. At this moment, the light emitted is at a small angle. When the surface B of the lens body 1 is the light incident surface, a part of light rays is incident into the lens body 1 through the concave cambered surface 8 and then emitted at the convex cambered surface 6 of a light-emitting surface. Another part of light rays is diffused via the concave cambered surface 8 through the first convex surface 3, the second convex surface 4, and the third convex surface 5 and then emitted. At this moment, the light emitted is at a large angle. In the present disclosure, a light-emitting angle may be adjusted only by turning the lens body 1, and compared with the focusing mode in the related art, this lens has the features of a smaller amount of material and a smaller weight and volume, thereby reducing the cost of the lens. The loss of optical efficiency caused by the conventional focusing mode is avoided, and meanwhile, only one layer of optical structure is provided, thereby reducing the loss of luminous flux. The angle adjustment is realized by turning, thereby improving the space utilization.

Specifically, the convex cambered surface 6 has a thickness of 0.6 mm.

Specifically, the first convex surface 3, the second convex surface 4, and the third convex surface 5 all have a zigzag structure.

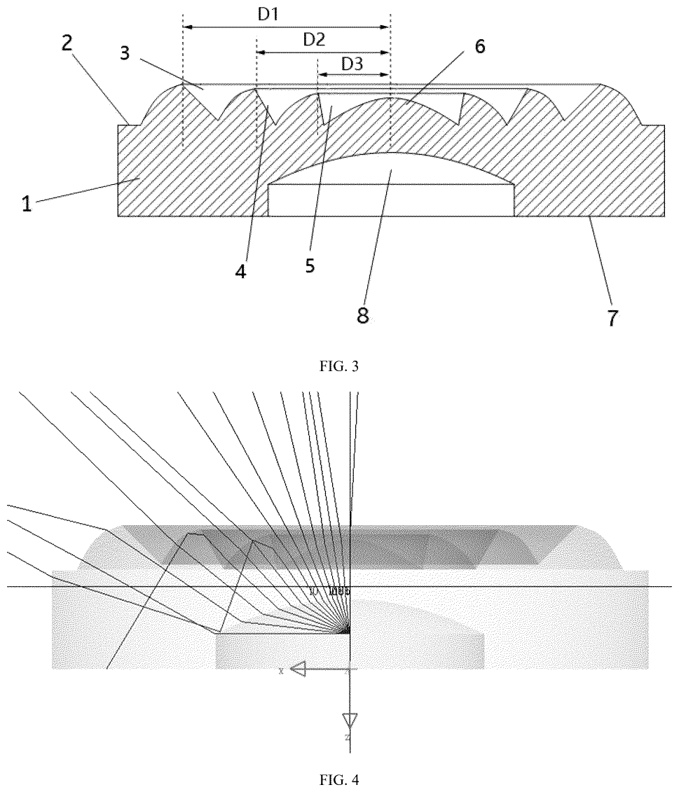

Specifically, as shown in FIG. 3, a distance D1 between a convex point of the first convex surface 3 and a central point of the lens body 1 is about 4.8 mm, a distance D2 between a convex point of the second convex surface 4 and the central point is about 3 mm, and a distance D3 between a convex point of the third convex surface 5 and the central point is about 1.6 mm.

As used herein, the term “about” means that sizes are not and need not be exact, but may be approximate and/or larger or smaller, as desired, reflecting tolerances, conversion factors, rounding off, measurement error and the like, and other factors known to those of skill in the art. When the term “about” is used in describing a value, the disclosure should be understood to include the specific value. Whether or not a numerical value in the specification recites “about,” the numerical value is intended to include two embodiments: one modified by “about,” and one not modified by “about.”

Specifically, each of the first convex surface 3, the second convex surface 4, and the third convex surface 5 includes an incident surface and an emitting surface, and the incident surface is provided opposite to the emitting surface.

Specifically, an angle between the incident surface of the first convex surface 3 and a horizontal plane is 135°, an angle between the incident surface of the second convex surface 4 and the horizontal plane is 120°, and an angle between the incident surface of the third convex surface 5 and the horizontal plane is 100°. Specifically, the concave cambered surface 8 has a thickness of 0.7 mm.

### Embodiment 2

Further, an implementation method of the angularly adjustable Fresnel turning lens according to the present disclosure includes the steps of:

(1) when a surface A of a lens body 1 is a light incident surface, a part of light rays being incident into the lens body 1 through a convex cambered surface 6 and then emitted; another part of light rays being converged through a first convex surface 3, a second convex surface 4, and a third convex surface 5, and then emitted; and at this moment, the light emitted being at a small angle; and

(2) when a surface B of the lens body 1 is the light incident surface, a part of light rays being incident into the lens body 1 through a concave cambered surface 8 and then emitted at the convex cambered surface 6 of a light-emitting surface; another part of light rays being incident via the concave cambered surface 8 and then diffused through the first convex surface 3, the second convex surface 4, and the third convex surface 5, and then emitted; and at this moment, the light emitted being at a large angle.

In summary, in the present disclosure, when the surface A of the lens body 1 is the light incident surface, a part of light rays is incident into the lens body 1 through the convex cambered surface 6 and then emitted. Another part of light rays is converged through the first convex surface 3, the second convex surface 4, and the third convex surface 5 and then emitted. At this moment, the light emitted is at a small angle. When the surface B of the lens body 1 is the light incident surface, a part of light rays is incident into the lens body 1 through the concave cambered surface 8 and then emitted at the convex cambered surface 6 of the light-emitting surface. Another part of light rays is diffused via the concave cambered surface 8 through the first convex surface 3, the second convex surface 4, and the third convex surface 5 and then emitted. At this moment, the light emitted is at a large angle. In the present disclosure, the light-emitting angle may be adjusted only by turning the lens body 1, and compared with the focusing mode in the related art, this lens has the features of a smaller amount of material and a smaller weight and volume, thereby reducing the cost of the lens. The loss of optical efficiency caused by the conventional focusing mode is avoided, and meanwhile, only one layer of optical structure is provided, thereby reducing the loss of luminous flux. The angle adjustment is realized by turning, thereby improving the space utilization.

While embodiments of the present disclosure have been shown and described, it will be understood by a person skilled in the art that various changes, modifications, substitutions, and alterations may be made herein without departing from the principles and spirit of the present disclosure, and the scope of the present disclosure is defined by the appended claims and their equivalents.

1. A Fresnel lens, comprising a lens body, wherein one side surface of the lens body is a surface A, and another side surface of the lens body is a surface B, wherein a convex cambered surface is provided at a middle position of the surface A, and a third convex surface, a second convex surface, and a first convex surface are provided successively at an outer side of the convex cambered surface; a concave cambered surface is arranged at a middle position of the surface B; the lens body is capable of being turned over to adjust a light-emitting angle of the Fresnel lens.

2. The Fresnel lens according to claim 1, wherein the convex cambered surface has a thickness of 0.6 mm.

3. The Fresnel lens according to claim 1, wherein the first convex surface, the second convex surface, and the third convex surface are all of a zigzag structure.

4. The Fresnel lens according to claim 3, wherein a distance between a convex point of the first convex surface and a central point of the lens body is about 4.8 mm, a distance between a convex point of the second convex surface and the central point is about 3 mm, and a distance between a convex point of the third convex surface and the central point is about 1.6 mm.

5. The Fresnel lens according to claim 1, wherein each of the first convex surface, the second convex surface, and the third convex surface comprises an incident surface and an emitting surface, and the incident surface is provided opposite to the emitting surface.

6. The Fresnel lens according to claim 5, wherein an angle between the incident surface of the first convex surface and a horizontal plane is 135°, an angle between the incident surface of the second convex surface and the horizontal plane is 120°, and an angle between the incident surface of the third convex surface and the horizontal plane is 100°.

7. The Fresnel lens according to claim 1, wherein the concave cambered surface has a thickness of 0.7 mm.

8. A method of adjusting the light-emitting angle of the Fresnel lens according to claim 1, comprising the steps of:
selecting one of the surface A and the surface B of the lens body as a light incident surface to allow the Fresnel lens to emit light at a first light-emitting angle; and
turning over the lens body to enable the other of the surface A and the surface B of the lens body to be a light incident surface to allow the Fresnel lens to emit light at a second light-emitting angle, thereby adjusting the light-emitting angle of the Fresnel lens.

9. The method of claim 8, wherein when the surface A of the lens body is the light incident surface, first light rays are incident into the lens body through the convex cambered surface and then emitted, second light rays are converged through the first convex surface, the second convex surface, and the third convex surface, and then emitted at the first light-emitting angle, and wherein the first light-emitting angle is a smaller angle than the second light-emitting angle.

10. The method of claim 8, wherein when the surface B of the lens body is the light incident surface, first light rays are incident into the lens body through the concave cambered surface and then emitted at the convex cambered surface of the light-emitting surface, second light rays are incident via the concave cambered surface and then diffused through the first convex surface, the second convex surface, and the third convex surface, and then emitted at the second light-emitting angle, and wherein the second light-emitting angle is a larger angle than the first light-emitting angle.
